(19) United States
(12) Patent Application Publication
(10) Pub. No.: US 2024/0062101 A1
(43) Pub. Date: Feb. 22, 2024

(54) FEATURE CONTRIBUTION SCORE CLASSIFICATION

(71) Applicant: BUSINESS OBJECTS SOFTWARE LTD, Dublin (IE)

(72) Inventor: Paul O'Hara, Dublin (IE)

(21) Appl. No.: 17/890,073

(22) Filed: Aug. 17, 2022

(51) Int. Cl. G06N 20/00

(52) U.S. Cl. CPC G06N 20/00

(57) ABSTRACT

A historical feature contribution score dataset comprising a number of sets of scores generated by machine learning model may be obtained. Additional feature contribution score sets may be materialized such that the size of each additional feature contribution score set is based on a corresponding randomly selected values within a set-size range. A training dataset may be produced that includes feature contribution scores and corresponding classification labels extracted from the historical feature contribution score dataset and the additional feature contribution score sets. The classification labels may indicate an amount that the corresponding feature contribution scores contribute to a prediction of a target feature. A machine learning model may be trained to predict the classification labels using the training dataset. An input feature contribution score set may be applied to the machine learning model to obtain predicted classification labels.

### BACKGROUND

The present disclosure pertains to machine learning and in particular to feature contribution score classification.

The integration of machine learning into enterprise systems data analytics offerings has increased, making the provision of machine learning augmented services a key component of modern enterprise systems data analytics offerings. Machine learning augmented analytic systems may provide meaningful insights to organizations across large sets of data, which, if done manually, would be time-consuming. Thus, they enable improved decision making within the organization while increasing efficiency.

However, utilizing machine learning may require highly skilled individuals to prepare data, train machine learning models, interpret results, and disseminate findings. There is a need for data analytic applications that provide features enabling non machine learning experts to utilize machine learning functionality.

### BRIEF DESCRIPTION OF THE DRAWINGS

FIG. 1 shows a diagram of a feature contribution classification system in communication with a client system, according to an embodiment.

FIG. 2 shows a flowchart of a method for classifying feature contribution scores, according to an embodiment.

FIG. 3 shows a diagram of an automatic category classification framework for feature contribution scores, according to an embodiment.

FIG. 4 shows a diagram of an augment feature contribution score dataset component, according to an embodiment.

FIG. 5 shows a diagram 500 of materializing labelled feature contribution score sets, according to an embodiment.

FIG. 6 shows a diagram 600 of feature contribution category classification feature extraction, according to an embodiment.

FIG. 7 shows a diagram 700 of a supervised feature contribution category classification learning task, according to an embodiment.

FIG. 8 shows a diagram 800 of applying the supervised feature contribution category classification model, according to an embodiment.

FIG. 9 shows a diagram of hardware of a special purpose computing system for implementing systems and methods described herein.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident, based on the language of the different claims, that the claimed subject matter may include some or all of the features in these examples, alone or in combination, and may further include modifications and equivalents of the features and techniques described herein. While certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner. In addition, hardwired circuitry may be used independently or in combination with software instructions to implement the techniques described in this disclosure. The described functionality may be performed by custom hardware components containing hardwired logic for performing operations, or by any combination of computer hardware and programmed computer components. The embodiments described in this disclosure are not limited to any specific combination of hardware circuitry or software. The embodiments can also be practiced in distributed computing environments where operations are performed by remote data processing devices or systems that are linked through one or more wired or wireless networks. Furthermore, the terms “first,” “second,” “third,” “fourth,” etc., used herein do not necessarily indicate an ordering or sequence unless indicated. These terms may merely be used for differentiation between different objects or elements without specifying an order.

As mentioned above, the integration of machine learning into enterprise systems data analytics offerings has increased, making the provision of machine learning augmented services a key component of modern enterprise systems data analytics offerings. Machine learning augmented analytic systems may provide meaningful insights to organizations across large sets of data, which, if done manually, would be time-consuming. Thus, they enable improved decision making within the organization while increasing efficiency.

However, utilizing machine learning may require highly skilled individuals to prepare data, train machine learning models, interpret results, and disseminate findings. Therefore, data analytic applications may provide features enabling non machine learning experts to utilize machine learning functionality. Such application may cover machine learning related tasks such as joining data, data cleaning, engineering additional features, machine learning model building, and interpretation of machine learning results, as further discussed in the following paragraphs.

Joining data refers to combining data from multiple distinct sources into a unified dataset from which further analysis can be performed. Enterprise systems employ various approaches to automatically suggest joins of data, including fuzzy matching, etc.

In general, incorrect or inconsistent data can lead to false conclusions. Data cleaning involves detecting and correcting corrupt or inaccurate records from a dataset. Once data cleaning process is complete, the data may be said to be in a consistent state and of high quality. Certain systems offer various tooling enabling the efficient identification and correction of inaccuracies in the data. Identification and correction of inaccuracies may include inferring data types, identifying linked data, standardizing data, and managing missing values.

Inferring data types may involve automatically identifying and setting the data type for the features of the data. For example, automatically ensuring numbers are stored as the correct numerical data type.

Often a value can be entered in many ways across system. For example, an address may be entered in various formats. Identifying linked data may involve techniques such as fuzzy matching, which can automatically suggest possible linked value items within the data, thereby allowing confirmation and mapping of the linked value items to a standard common value item.

Standardizing data may involve automatically placing data in a standardize format. For instance, setting all textual entries to be lower or uppercase. For numerical data standardizing could ensuring all values utilize a common measurement unit, for example grams.

Missing values often occur in data. Managing missing values may involve automatically providing several options to users on how to manage the missing data, such as dropping the data from the dataset, imputing the missing data using existing data, or flag the data as missing.

Engineering additional features is another machine learning task that data analytic applications may enable non-expert users to utilize. Engineering of additional features may involve a further round of data preparation performed on the data (e.g., the cleaned data). Feature engineering may involve extracting additional columns (features) from the data. The features extracted may provide additional information in relation to the data related task, thereby improving the performance of the applied machine learning data analysis approach. Data analytics systems and solutions may provide multiple feature engineering templates that non expert users can apply to data, such as one-hot encoding, numerically encoding high cardinality categorical variables, and breaking down features. One-hot encoding may involve converting each category of a categorical feature into a new categorical column and for each row in the data assign a binary value of 1 or 0 to the new columns depending on the value of the category for the categorical feature for each row. Once one-hot encoding is complete, the original categorical feature may be discarded. Breaking down features may involve creating several separate features. For example, a date feature can be separated into day of the week, month, year, a Boolean variable indicating the day is a public holiday, etc.

Machine learning model building is another machine learning task that data analytic applications may enable non-expert users to utilize. Machine learning model building may involve selecting a primary feature from the prepared dataset (often referred to as the “target feature”) and related features (often referred to as the “input features”) for data analysis and a machine learning model build. Machine learning tasks such as classification and regression may be the core of the data analysis. Certain data analytic solutions may automate the machine learning model building process. Once the target feature and input dataset are selected, the data analytic solution may automatically build several classification/regression models with the best model selected based on metrics such as accuracy, robustness, and simplicity.

Interpretation of machine learning results is another machine learning task that data analytic applications may enable non-expert users to utilize. Interpretation of the results may include presenting a dashboard conveying an overview of the performance of the machine learning model, in a digestible interpretable format for non-expert users. Information may include a summary of the results, details of the input features with the strongest influence on the target of the machine learning model, and information on outliers in the data.

Through utilizing an automated data processing tools and machine learning modelling functionality, non-expert users can utilize machine learning to explore and analyze data, uncovering valuable insights. The insights and data learnings may then be translated into operational decisions.

As part of interpreting the machine learning model, a key component is understanding each input features contribution—or influence—on the target feature. In determining “feature contribution,” a score may be assigned to each input feature, indicating the relative contribution of each feature towards the target feature. Feature contribution scores are advantageous as they may enable better understanding of the data, better understanding of the learned model, and may reduce the number of input features as features with low contribution scores may be discarded.

A better understanding of the data may be provided by feature contribution scores as the relative scores highlight the features most relevant to the target feature, and consequently the input features of least relevance. This insight can then be utilized, for example, as a basis for gathering additional data.

Better understanding of the learned model may be provided by feature contribution scores as the contribution scores are calculated through interpreting a machine learning model built from a prepared dataset. Through inspection of feature contribution scores, insights into the built model's degree of dependency on each input feature when making a prediction can be achieved.

And it is possible to reduce the number of input features through discarding features with low feature contribution scores. Reducing the number of input features may simplify the problem to be modelled, and speeds up the modelling process, and in some cases improves model performance.

Some challenge may arise when interpreting feature contribution scores for non-experts. For instance, when feature contribution scores are numeric, that may make it challenging for non-experts to interpret. Also, the interpretation of the feature contribution scores may vary from model to model, which may be challenging for a non-expert user to correctly interpret. For example, a feature with 20% influence from a model with 5-input features should not be interpreted the same as a feature with a 20% influence from a 100-input feature model. That is, one feature having a 20% influence compared to 99 other features is more significant than one feature having a 20% influence compared to 4 other features.

Given the above considerations, there is a need for an intelligent solution that facilitates the efficient mapping of sets of machine learning feature contribution scores to accurate feature contribution labels (e.g., categorical labels). The mapped feature contribution labels may enable greater interpretation of machine learning feature contribution scores by non-expert users, facilitating insight discovery and decision making. Such an intelligent solution would be considered advantageous and desirable to organizations.

The present disclosure provides feature contribution classification techniques (e.g., systems, computer programs, and methods) for determining feature contribution scores where the category classification for a set of feature contribution scores is accurately predicted against a set of predefined labels by an intelligent category classification component. Advantageously, the intelligent category classification process used within this framework may be model agnostic. That is, it is independent of the machine learning model the set of feature contribution scores are derived from. This independence provides great flexibility enabling the feature contribution classification techniques for feature contribution scores to be applied against any machine learning model.

One advantage of mapping feature contribution scores to feature contribution labels is that the framework facilities increased model interpretability for the non-expert user. One advantage of labelling the feature contribution scores is that the framework ensures consistent interpretation by the user, reducing possible misinterpretation of similar contribution scores from feature contribution score sets of different sizes. This further facilitates understanding of a feature's contribution across multiple models allowing greater attention towards insight discovery.

The feature contribution classification techniques described here provide an intelligent supervised feature contribution category classification prediction model that may enable accurate and consistent predictive labelling of feature contribution scores from sets of any size. The model may take as input the feature contribution score, several engineered features, and predicts the category classification for the input feature contribution score from the set of predefined labels (categories) the model was trained against. With this technique there may be no limit on the number of category classification labels that can be defined.

The feature contribution classification technique may also be independent of feature contribution set size, thereby providing an advantage over prior algorithmic directions having a dependence on feature contribution set size as an input parameter. For example, a prior classification direction utilizing historical feature contribution sets to derive average category classification thresholds per feature contribution set size would be disadvantaged to this feature contribution classification techniques described herein. For instance, if insufficient feature contribution sets exist of a particular size, the accuracy of assigned category classification by the direction dependent on set size is unable to be guaranteed. Whereas the accuracy of the classification techniques disclosed herein may remain consistent due to their independence from feature contribution set size.

Furthermore, the feature contribution classification techniques disclosed herein may utilize a trained feature contribution category classification model to accurately predict the category classification labels for new feature contribution score sets produced from a machine learning model, outputting interpretable feature contribution category classification labels.

Experiments conducted by the inventor demonstrate the proposed framework achieved 98% category classification accuracy across several sample feature contribution score sets of varying sizes where three category classification labels were defined. Furthermore, for each available category classification label accuracy of 99%, 93%, and 88% were achieved, superior to other prior classification approaches.

Therefore, the proposed framework enables the intelligent prediction of reliable and accurate interpretable feature contribution category classification labels for feature contribution score sets from one of several available interpretable category classification labels. This increases model interpretability for non-expert users.

Further features and advantages of the feature contribution classification techniques disclosed herein include a framework allowing interpretable feature contribution category classification labels to be accurately and efficiently predicted for feature contribution score sets by an intelligent component; a framework that is machine learning model agnostic—enabling the framework to be applied against any machine learning model; framework where no limit exists on the number of category classification labels that can be defined; a machine learning model that can take as input a feature contribution score, and several engineered features based on the feature contribution set, that is capable of consistently predicting an interpretable category classification label for the feature contribution score with high accuracy and across all defined category classification labels; a category classification process independent of feature contribution set size, providing an application advantage over directions dependent on feature contribution set size as an input; and a framework ensuring consistent labelling, removing possible misinterpretation of similar contribution scores from feature contribution sets of different sizes, facilitating intuitive understanding for non-machine learning experts.

### Terms

The following terms used herein are defined as follows.

Feature: A feature is a measurable property of the data to be analyzed and/or predicted. In tabular datasets, each column represents a feature.

Input Features: These represent the independent variables selected as the input to the machine learning model to be built.

Target Feature: The target feature represents the column of the dataset to be the focus of the machine learning model. The target feature is dependent on the input features. It is expected as the values of the independent features change, the value of the target feature will accordingly vary.

Machine Learning Model: A machine learning model is the output of a machine learning algorithm trained on an input dataset. The machine learning model represents what was learned by a machine learning algorithm and is used to make inferences/predictions on new data.

Feature Contribution Score: refers to techniques that assign score to input features based on how they contribute to the prediction of a target feature. Feature contribution scores may play an important role in a machine learning modelling, providing insight into the data, insight into the model, and the basis for feature selection that can improve the efficiency and effectiveness of a machine learning model.

### Feature Contribution Classification System and Method

The automatic category classification techniques for feature contribution scores described herein may be applied to any set of feature contribution scores produced from a machine learning model. Automatic classification of the feature contribution scores described herein focuses on enabling non-machine learning experts to interpret the influence of input features on the target feature from a learned machine learning model where feature contributions scores are extracted. Through the application of these classification techniques, the ability for a non-machine learning expert to consistently reasonably interpret feature contribution scores produced from models composed of differing feature set sizes is enhanced.

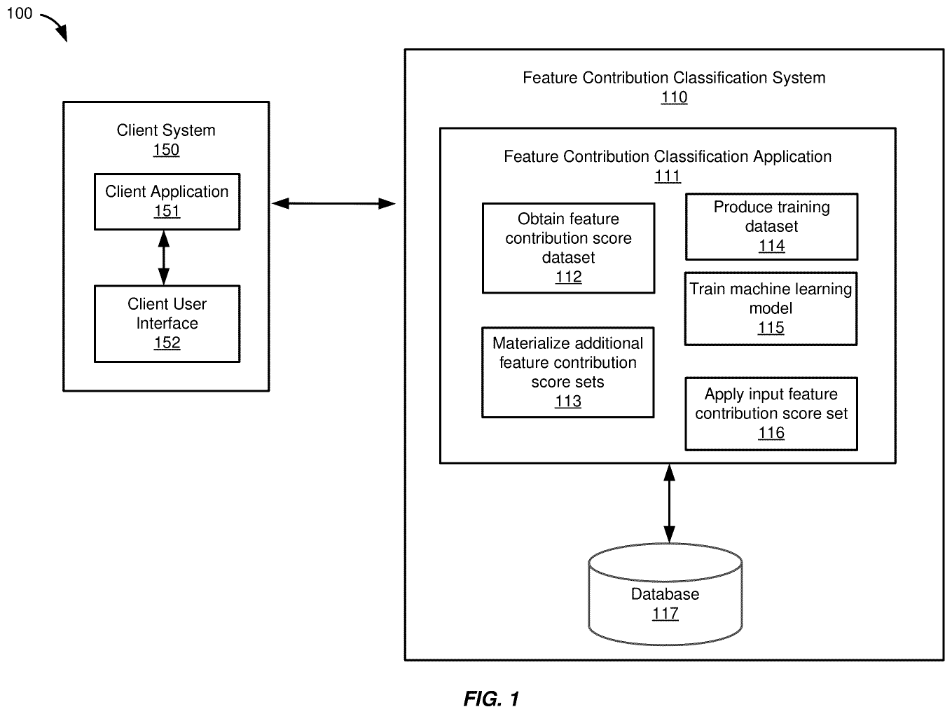

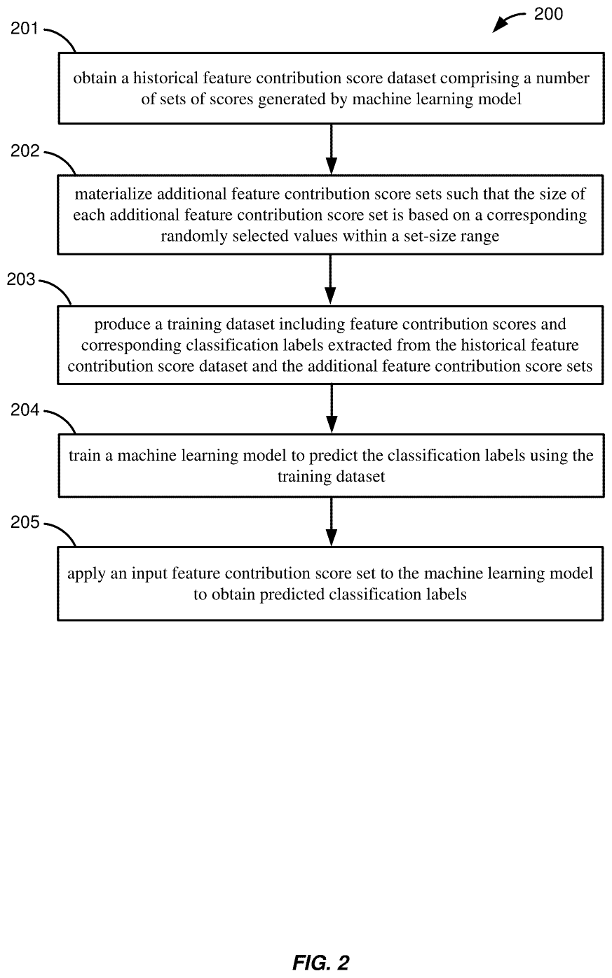

The automatic category classification techniques for feature contribution scores solution described herein may be implemented by a feature contribution classification computer system as described below with respect to FIG. 1 and it may be implemented as the method described below with respect to FIG. 2.

A feature contribution classification computer system (“classification system”) may be configured to implement the automatic category classification techniques and framework described herein. FIG. 1 shows a diagram 100 of a feature contribution classification system 110 in communication with a client system 150, according to an embodiment. The feature contribution classification system 110 of FIG. 1 may implement the techniques described below with respect to FIG. 2-8.

The feature contribution classification system 110 may comprise one or more server computers including one or more database servers. The feature contribution classification system may provide a feature contribution classification software application 111 configured to train machine learning models to classify feature contribution scores and configured to apply an input set of feature contribution scores to a particular model to obtain classifications as output. The feature contribution classification application 111 may implement the Automatic Category Classification Framework for Feature Contribution Scores solution described in detail below. In some embodiments the feature contribution classification software application 111 may be provided using a cloud-based platform or an on-premise platform, for example. Datasets for training the machine learning models and the models themselves may be stored in a database 117.

Components of the feature contribution classification application 111 include an obtain feature contribution score dataset 112 component, a materialize additional feature contribution score sets 113 component, a produce training dataset 114 component, a train machine learning model 115 component, and an apply input feature contribution score set 116 component.

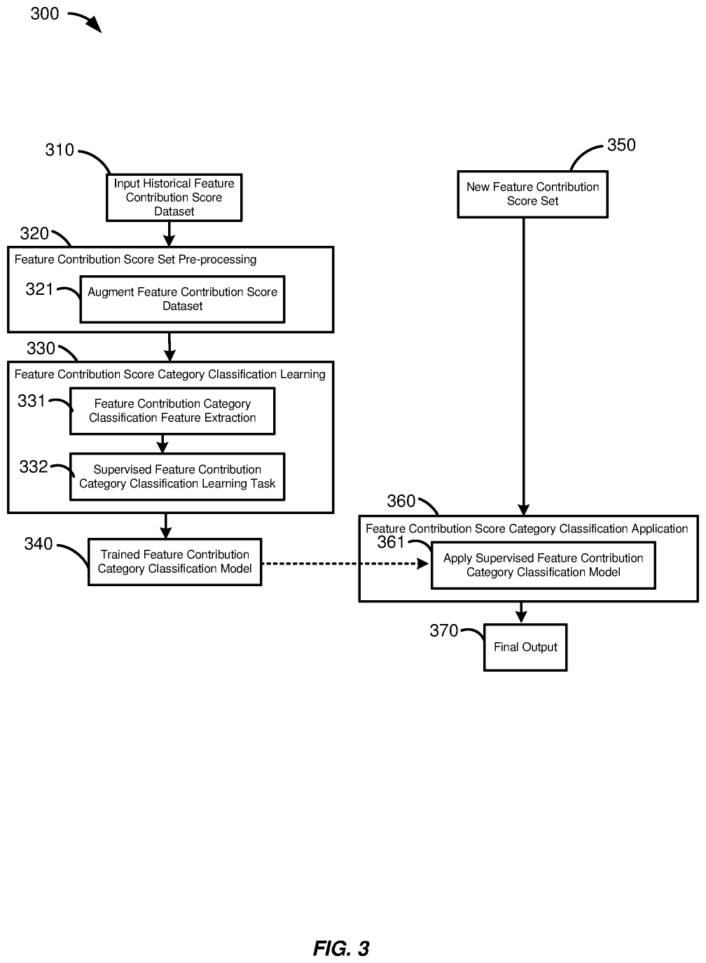

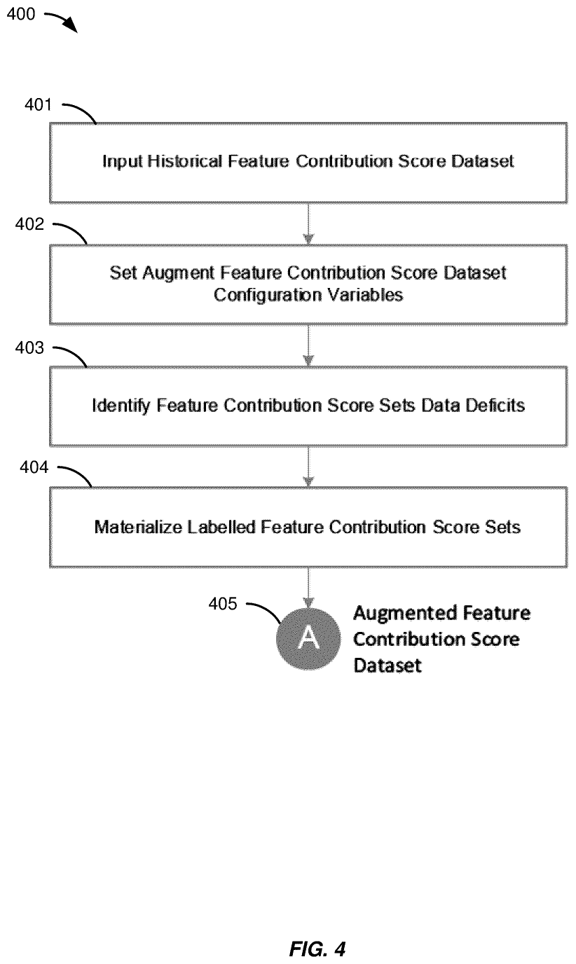

The obtain feature contribution score dataset 112 component may be configured to obtain a historical feature contribution score dataset comprising a number of sets of scores generated by machine learning model. The historical feature contribution score dataset is further described below with respect to FIG. 3 and FIG. 4.

The materialize additional feature contribution score sets 113 component may be configured to materialize additional feature contribution score sets such that the size of each additional feature contribution score set is based on a corresponding randomly selected values within a set-size range. In some embodiments, the materializing of additional feature contribution score sets includes randomly generating scores based on a number of sample score-ranges. In some embodiments, the materializing of additional feature contribution score sets includes normalizing score values of the additional feature contribution score. In some embodiments classification labels are assigned to the scores of additional feature contribution score sets after they are materialized. Some embodiments further include determining a deficit number based on the number of the sets of scores in the feature contribution score dataset and a predefined number of feature contribution score sets. In such embodiments the materializing of the additional feature contribution score sets is based on the deficit number. The materializing of additional features contribution score sets is further described below with respect to FIG. 3 and FIG. 4.

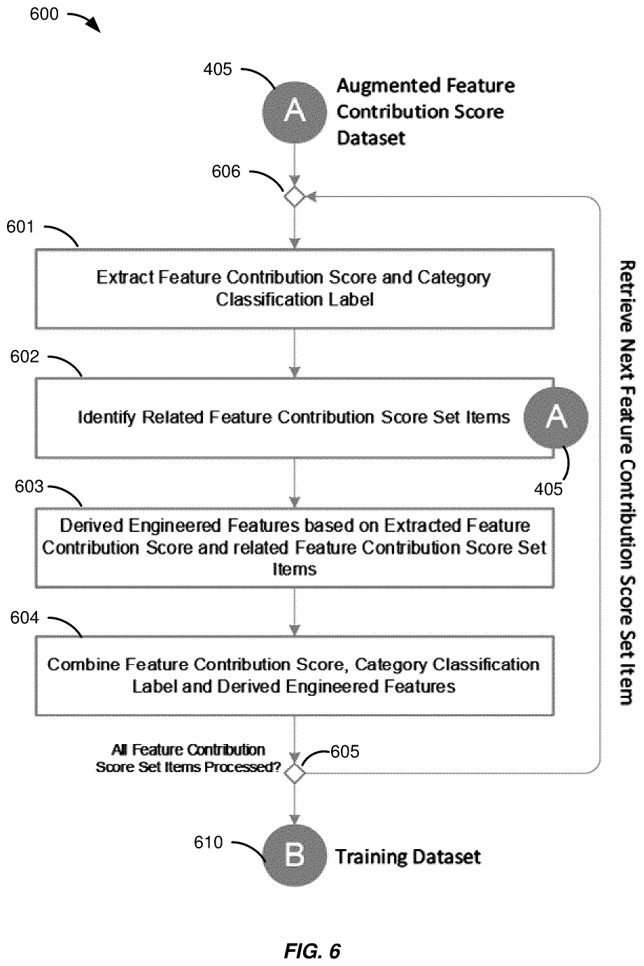

In some embodiments the feature contribution classification application 111 is further configured to derive engineered features based on the historical feature contribution score dataset and the additional feature contribution score sets. The derived engineered features may be based on one or more of a maximum feature contribution score, a minimum feature contribution score, a mean feature contribution score, a distance to the maximum feature contribution score, a distance to the minimum feature contribution score, a distance to the mean feature contribution score, and a variance of feature contribution scores. The deriving of engineered features is further described below with respect to FIG. 6.

The produce training dataset 114 component may be configured to produce a training dataset including feature contribution scores and corresponding classification labels extracted from the historical feature contribution score dataset and the additional feature contribution score sets. The classification labels may indicate an amount that the corresponding feature contribution scores contribute to a prediction of a target feature. The producing of the training data set is further described below with respect to FIG. 6.

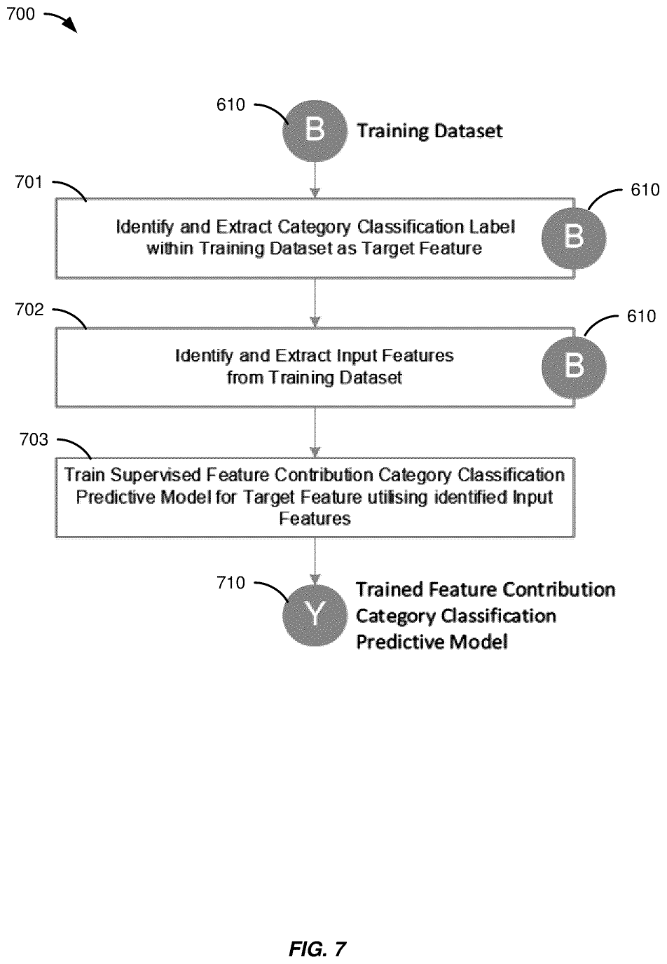

The train machine learning model 115 component may be configured to train a machine learning model to predict the classification labels using the training dataset. The training of the machine learning model is further described below with respect to FIG. 7.

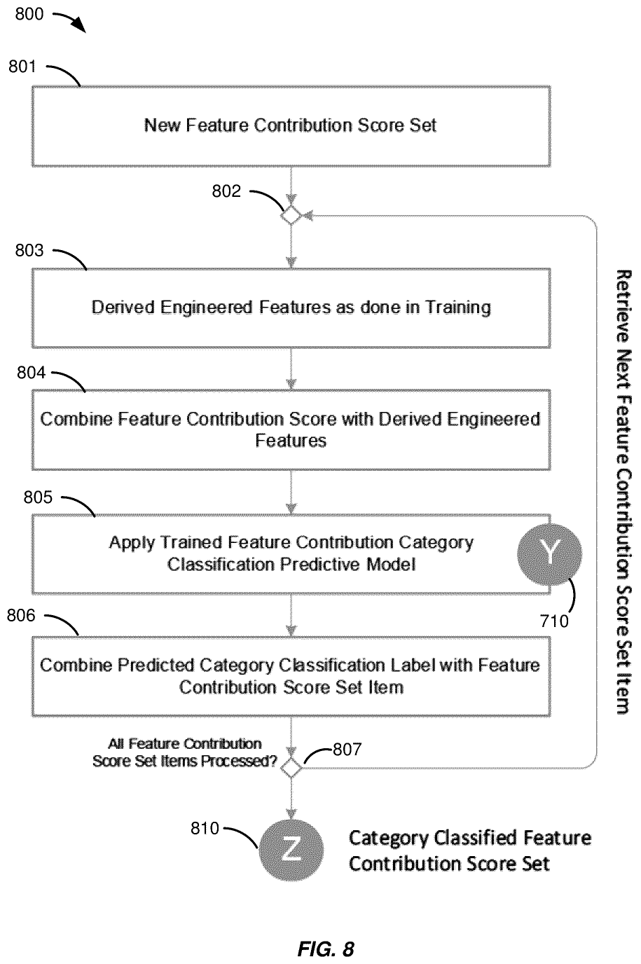

The apply input feature contribution score set 116 component may be configured to apply an input feature contribution score set to the machine learning model to obtain predicted classification labels. Some embodiments further include deriving engineered features based on the input feature contribution score set. In such embodiments the input feature contribution score set applied to the machine learning model is based on the engineered features derived based on the input feature contribution score set. The application of the input feature contribution score set to the machine learning model is further described below with respect to FIGS. 3 and 8.

The client system 150 includes a client application 151. The client application 151 may be a software application or a web browser, for example. The client application 151 may be capable of rendering or presenting visualizations on a client user interface 152. The client user interface may include a display device for displaying visualizations and one or more input methods for obtaining input from a user of the client system 150.

The client system 150 may communicate with the feature contribution classification system 110 (e.g., over a local network or the Internet). For example, the client application 151 may provide the input feature contribution score set. The client application 151 may also be configured to apply labels to materialized feature contribution score sets.

The feature contribution classification techniques that may be implemented by the feature contribution classification system 110 are described in further detail below.

FIG. 2 shows a flowchart 200 of a method for classifying feature contribution scores, according to an embodiment. In some embodiments the method may be implemented by the feature contribution classification system 110. The method of FIG. 2 may be expanded upon using the techniques described below with respect to FIG. 3-8.

At 201, obtain a historical feature contribution score dataset comprising a number of sets of scores generated by machine learning model. The historical feature contribution score dataset is further described below with respect to FIG. 3 and FIG. 4.

At 202, materialize additional feature contribution score sets such that the size of each additional feature contribution score set is based on a corresponding randomly selected values within a set-size range. In some embodiments, the materializing of additional feature contribution score sets includes randomly generating scores based on a number of sample score-ranges. In some embodiments, the materializing of additional feature contribution score sets includes normalizing score values of the additional feature contribution score. In some embodiments classification labels are assigned to the scores of additional feature contribution score sets after they are materialized. Some embodiments further include determining a deficit number based on the number of the sets of scores in the feature contribution score dataset and a predefined number of feature contribution score sets. In such embodiments the materializing of the additional feature contribution score sets is based on the deficit number. The materializing of additional features contribution score sets is further described below with respect to FIG. 3 and FIG. 4.

Some embodiments further include deriving engineered features based on the historical feature contribution score dataset and the additional feature contribution score sets. The derived engineered features may be based on one or more of a maximum feature contribution score, a minimum feature contribution score, a mean feature contribution score, a distance to the maximum feature contribution score, a distance to the minimum feature contribution score, a distance to the mean feature contribution score, and a variance of feature contribution scores. The deriving of engineered features is further described below with respect to FIG. 6.

At 203, produce a training dataset including feature contribution scores and corresponding classification labels extracted from the historical feature contribution score dataset and the additional feature contribution score sets, The classification labels may indicate an amount that the corresponding feature contribution scores contribute to a prediction of a target feature. The producing of the training data set is further described below with respect to FIG. 6.

At 204, train a machine learning model to predict the classification labels using the training dataset. The training of the machine learning model is further described below with respect to FIG. 7.

At 205, apply an input feature contribution score set to the machine learning model to obtain predicted classification labels. Some embodiments further include deriving engineered features based on the input feature contribution score set. In such embodiments the input feature contribution score set applied to the machine learning model is based on the engineered features derived based on the input feature contribution score set. The application of the input feature contribution score set to the machine learning model is further described below with respect to FIGS. 3 and 8.

### Automatic Category Classification Framework for Feature Contribution Scores

FIG. 3 shows a diagram 300 of an automatic category classification framework for feature contribution scores, according to an embodiment. As shown in FIG. 3, the proposed solution consists of an architecture applicable to input datasets consisting of historical feature contribution score sets. The architecture consists of three parts, Feature Contribution Score Pre-processing 320, Feature Contribution Score Category Classification Learning 330, and Feature Contribution Score Category Classification Application 360. Feature Contribution Score Set Pre-processing 320 consists of one component, Augment Feature Contribution Score Dataset 321. The Augment Feature Contribution Score Dataset component 321 takes as input an Input Historical Feature Contribution Score Dataset 310, augmenting it where additional labelled feature contribution score sets are materialized if a data deficiency is identified. The labelled feature contribution score sets are materialized of multiple sizes with the required number of feature contribution score sets generated. The required number of feature contribution score sets is configurable. In some embodiments, the dataset was augmented to ensure 3000 feature contribution score sets are generated with feature contribution sets sizes configured to randomly range from 2 to 200. The materialized labelled feature contribution score sets are combined with the input historical feature contribution score dataset producing the augmented feature contribution score dataset, where the required number of feature contribution score set samples exist. The augmented feature contribution score dataset is then passed to the Feature Contribution Score Category Classification Learning 330 part.

The Feature Contribution Score Category Classification Learning part 330 takes as input the Augmented Feature Contribution Score Dataset and for each feature contribution score item (e.g., row) extracts the score, category classification label and proceeds to engineer additional input features based on the feature contribution scores of the feature contribution set the feature contribution score item is in relation to. The engineered features are combined with the feature contribution score and category classification label producing the training dataset that is then used to train the supervised feature contribution category classification predictive model. The output is a trained predictive model 340 capable of predicting the category classification label for an input feature contribution score with high accuracy. The output predictive model 340 is then utilized by the Feature Contribution Score Category Classification Application 360 part.

The Feature Contribution Score Category Classification Application 360 part consists of one component, Apply Supervised Feature Contribution Category Classification Model 361. The Apply Supervised Feature Contribution Category Classification Model 361 takes as input a New Feature Contribution Score Set 350 and the trained predictive model 340. For each feature contribution score item of the New Feature Contribution Score Set 350, the same engineered features as used in training are derived and combined with the score of the feature contribution score item. Then, the trained predictive model 340 is applied to obtain the required predicted category classification label for each feature contribution score item of the input New Feature Contribution Score Set 350.

The output 370 is Feature Contribution Score Category Classifications for each Feature Contribution Score Set item of a New Feature Contribution Score Set that clearly and intuitively communicate to non-expert users each feature contribution score set items strength of contribution towards a selected target feature. Thus, ensuring non-expert machine learning users can consistently interpret the influence of input features on a selected target feature from a learned machine learning model of differing feature set sizes where feature contributions scores are extracted. This solution is discussed in more detail below.

### Feature Contribution Score Set Pre-Processing

As discussed above with respect to FIG. 3, the Feature Contribution Score Pre-processing 320 part consist of one component, Augment Feature Contribution Score Dataset 321. The Augment Feature Contribution Score Dataset 321 component takes the Input Historical Feature Contribution Score Dataset 310 as input, augmenting it to include additional materialized feature contribution score sets where a deficit in the required number of samples of Feature Contribution Score Sets was identified. This component is discussed in more detail below with respect to FIG. 4.

FIG. 4 shows a diagram 400 of an augment feature contribution score dataset component, according to an embodiment. At 401, a Historical Feature Contribution Score Dataset is passed to the Augment Feature Contribution Score Dataset component as input. The input historical feature contribution score dataset represents historical feature contribution scores sets output from previously trained machine learning models. The Input Historical Feature Contribution Score Dataset is structured and presented in tabular form. Within the tabular format, columns represent information regarding a feature contribution score and rows hold the values of these features relative to their respective columns. The columns of input historical feature contribution score dataset represent continuous and categorical data where a Continuous Feature denotes numeric data having an infinite number of possible values within a selected range (e.g., temperature) and where a Categorical Feature denotes data containing a finite number of possible categories (e.g., days of the week, gender, unique identifier, etc.). The data may or may not have a logical order.

In some embodiments the input historical feature contribution score tabular dataset may consists of three columns: Feature Contribution Score Set Identifier, Score, and Category Classification. Feature Contribution Score Set Identifier is a unique identifier indicating the feature contribution score set the feature contribution score exists in relation to. Score is the feature contribution score, indicating the level of influence the feature has on the target feature. Category Classification is the category classification label assigned to the feature contribution score. The input historical feature contribution score set may have previously been examined and the appropriate classification category—from one of the available category classification labels—assigned.

At 402, the augment feature contribution score configurations are set. The framework described herein may define configurations (e.g., Number of Feature Contribution Score Sets, Feature Contribution Score Set Size Range) outlining the required number of feature contribution score sets, and range of feature contribution set sizes materialized samples must exist within. For instance, the dataset may be augmented to ensure a minimum of 3000 feature contribution score sets exists, with feature contribution sets sizes configured to range from 2 to 200, as one example.

A 403, utilizing the input historical feature contribution score set records, the required number of feature contribution score sets configuration is accessed and the deficit between the number of input historical feature contribution score sets and required number of feature contribution score sets calculated.

At 404, if a deficit exists, the Feature Contribution Score Set Sampler Algorithm is applied, and additional labelled feature contribution score sets materialized.

Referring back to the feature contribution score configurations mentioned above, these configurations may include configuration properties such as the number of feature contribution score sets (e.g., 3000, etc.), the feature contribution score set size range (e.g., 2-200, etc.), the number of sample ranges (e.g., 20, etc.), category classification labels (e.g., weak, moderate, strong, etc.).

The number of feature contribution score sets may defines the required number of feature contribution score sets that must exist and may be used when materializing the augmented feature contribution score dataset.

The feature contribution score set size range list indicating the ranges of feature contribution score set sizes examples must exist for and may be used when materializing the augmented feature contribution score dataset.

The number of sample ranges number may indicate the number of sample ranges to be generated from which the raw feature contribution scores will be sampled from and may be used as part of the feature contribution score set sampler algorithm.

The category classification labels refers to the classification labels for the feature contribution scores as classified by the classification techniques described herein.

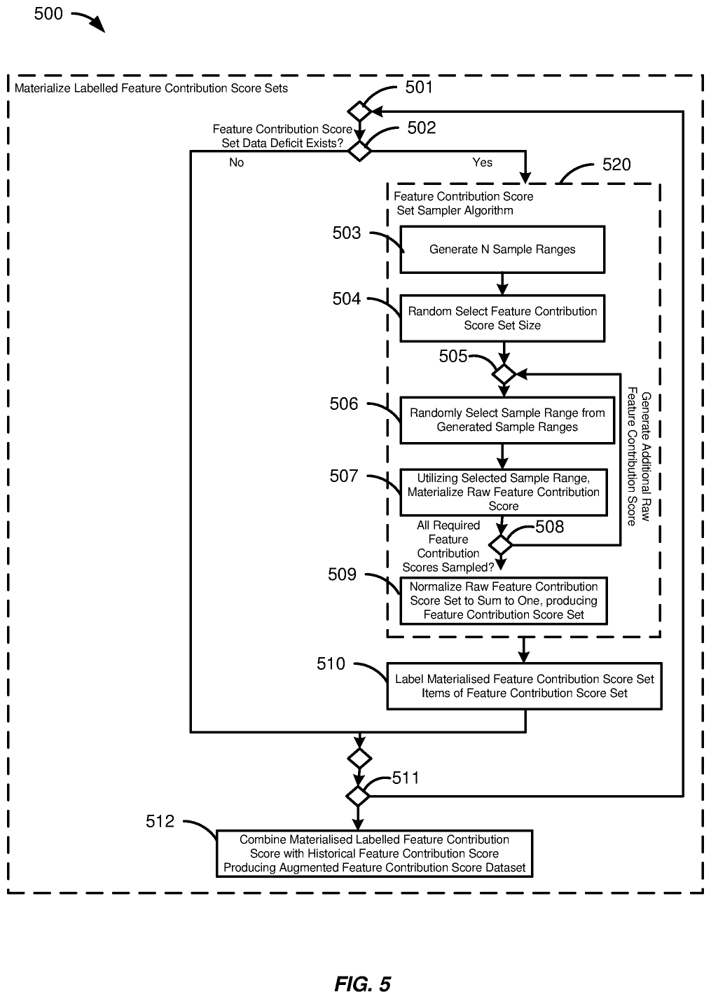

As mentioned above with respect to 404, if a deficit exists, the Feature Contribution Score Set Sampler Algorithm is applied, and additional labelled feature contribution score sets materialized. FIG. 5 shows a diagram 500 of materializing labelled feature contribution score sets, according to an embodiment. At 502, if a deficit exists (“Yes” at 502), the Feature Contribution Score Set Sampler Algorithm 520 is applied. If not (“No” at 502) the process continues to 511 to determine whether the feature contribution score set data deficit is address. If the deficit is addressed, at 512 the process may combine materialized labelled feature contribution score with historical feature contribution score to produce an augmented feature contribution score dataset. If the deficit is not address, the process returns to 501 and then 502 to determine if a deficit exists.

To materialize a labelled feature contribution score set, at 503 a Feature Contribution Score Set Sampler Algorithm 520 generates n sample ranges (e.g., based on Configuration Property: Number Sample Ranges) the raw feature contribution scores will be sampled from. Each sample range generated represents a range with a minimum value of 0.0 and maximum value produced through some random value generation process. At 504, a random value generation process can utilize any random value generation process with a constraint, in some embodiments, it must be positive and greater than 0. In some embodiments, the configuration property is set to 20, resulting in 20 sample ranges generated and the random value generation process producing maximum sample range values through sampling from a uniform distribution with values between 0 and 1.

Then the algorithm randomly selects a value within the defined Feature Contribution Score Set Size Range configurable property, representing the size of the feature contribution score set size to be materialized. In some embodiments, the feature contribution sets size range property is configured to range from 2 to 200 with the value selected randomly based on a uniform distribution.

At 506, for each required feature contribution score, a sample range is randomly selected with each sample range equally likely to be selected. At 507, a raw feature contribution score is materialized. At 508 the algorithm determines if all requires feature contribution scores are sampled. If they are, the algorithm continues to 509. If not, the algorithm returns to 505 then 506.

At 509, after the required number of feature contribution scores have been generated for the set, a SoftMax function is applied to the raw feature contribution score values normalizing all values to be between 0 and 1 and sum to 1. The result of 509 is a sample feature contribution score set whose values simulate a realistic feature contribution score set. At 510 the feature contribution score set is labelled, where each feature contribution score set item from the feature contribution score set is inspected, and the appropriate category classification label assigned.

By decision 511 the process is repeated until sufficient labelled feature contribution score sets exist as described by the Number of Feature Contribution Score Sets configuration property. Additional details describing configuration properties utilized were discussed above.

At 512, the materialized labelled feature contribution score sets are combined with the input historical feature contribution score dataset producing the augmented feature contribution score dataset, where the required number of feature contribution score sets exist. The augmented feature contribution score dataset is then passed to the Feature Contribution Score Category Classification Learning part (e.g., 330 in FIG. 3) as discussed above.

### Feature Contribution Score Category Classification Learning

Referring to FIG. 3, the Feature Contribution Score Category Classification Learning part 330 consist of two components, Feature Contribution Category Classification Feature Extraction 331 and Supervised Feature Contribution Category Classification Learning Task 332.

The Feature Contribution Category Classification Feature Extraction component 331 takes the Augmented Feature Contribution Score Dataset (405 in FIG. 4) as input and for each row extracts the score and category classification label from the feature contribution score item. Then, additional features are engineered based on the extracted score and the feature contribution scores of the feature contribution set the feature contribution score item is in relation to. The engineered features are combined with the feature contribution score and category classification label producing as output the training dataset. The output training dataset is then passed to the Supervised Feature Contribution Category Classification Learning Task 332 component. The Feature Contribution Category Classification Feature Extraction component 331 is described in further detail below with respect to FIG. 6.

The Supervised Feature Contribution Category Classification Learning Task component 332 takes as input the training dataset and a classification predictive model is trained by performing a supervised learning algorithm to fulfil the prediction task. The output is a trained predictive classification model 340 capable of predicting the category classification label for an input feature contribution score set 350 with high accuracy. The output predictive classification model 340 is then utilized by the Feature Contribution Score Category Classification Application part 360. The components of the Feature Contribution Score Category Classification Learning part 330 are discussed in more detail below. The Supervised Feature Contribution Category Classification Learning Task component 332 is described in further detail below with respect to FIG. 7.

The Feature Contribution Category Classification Feature Extraction component 331 of FIG. 3 is described in detail with respect to FIG. 6. FIG. 6 shows a diagram 600 of feature contribution category classification feature extraction, according to an embodiment. The Feature Contribution Category Classification Feature Extraction component 331 takes as input the augmented feature contribution score dataset 405.

At 601, for each feature contribution Score Set Item of the dataset, the feature contribution score and category classification label are identified and extracted.

At 602, the related Feature Contribution Score Set Items of the feature contribution score set for the current Feature Contribution Score Set Item are identified.

At 603 the related Feature Contribution Score Set Items are utilized to engineer additional input features based on their feature contribution scores and the extracted feature contribution score of the current feature contribution score set item. The engineered features may inform on the distribution of the feature contribution score set the feature contribution score set item is related to as well as the contribution score of feature contribution score items association with the feature contribution score set distribution. Through engineering features to represent the distribution of the feature contribution set and the feature contribution scores position within the distribution, an underlying predictive model may be better able to accurately predict the appropriate category classification label.

The engineered features may include one or more of Distance to Maximum, Distance to Minimum, Distance to Mean, Maximum Score, Minimum Score, Mean, and Variance, for example.

The Distance to Maximum engineered feature may be the difference between current feature contribution score and the Maximum feature contribution score within the Feature Contribution Score Set the current feature contribution score is part of.

The Distance to Minimum engineered feature may be the difference between current feature contribution score and the Minimum feature contribution score within the Feature Contribution Score Set the current feature contribution score is part of.

The Distance to Mean engineered feature may be the difference between current feature contribution score and the Average feature contribution score within the Feature Contribution Score Set the current feature contribution score is part of.

The Maximum Score engineered feature may be the maximum feature contribution score within the Feature Contribution Score Set the current feature contribution score is part of.

The Minimum Score engineered feature may be the minimum feature contribution score within the Feature Contribution Score Set the current feature contribution score is part of.

The Mean engineered feature may be the average feature contribution score within the Feature Contribution Score Set the current feature contribution score is part of

The Variance engineered feature may be the variance of the feature contribution scores within the Feature Contribution Score Set the current feature contribution score is part of.

At 604 the feature contribution score and category classification label are then combined with the engineered features producing a training set item.

At 605 it is determined whether all feature contribution score set items are processed. The process is repeated, returning to 606 then 601, until all feature contribution score set items are processed. The output is a training dataset 610, where each row represents an achieved feature contribution score, the associated category classification label, and several engineered features describing the distribution of the related feature contribution score set and the feature contribution scores position with the distribution. The output training dataset 610 is then passed to the Supervised Feature Contribution Category Classification Learning Task (332 in FIG. 3), which id described in further detail with respect to FIG. 7.

FIG. 7 shows a diagram 700 of a supervised feature contribution category classification learning task, according to an embodiment.

The Supervised Feature Contribution Category Classification Learning Task component (332 in FIG. 3) takes the Training Dataset 610 (which is based on the Augmented Feature Contribution Score Dataset 405) as input.

At 701, when the Training Dataset 610 is obtained, the Category Classification Label is identified and selected as the Target Feature.

At 702 the remaining features (e.g., features that are not the Target Feature) are identified as the Input Features for the supervised learning algorithm.

At 703, using the identified input and target features, a predictive model is trained by performing a supervised learning algorithm to fulfil the category classification prediction problem.

The output is a trained Feature Contribution Category Classification Predictive Model 710 capable of addressing the category classification predictive problem with high accuracy. The output Feature Contribution Category Classification Predictive Model 710 is then passed to and utilized by the Feature Contribution Score Category Classification Application part (360 in FIG. 3).

### Feature Contribution Score Category Classification Application

Referring back to FIG. 3, the Feature Contribution Score Category Classification Application part 360 consist of one component, Apply Supervised Feature Contribution Category Classification Model 361. The Apply Supervised Feature Contribution Category Classification Model component 361 takes a New Feature Contribution Score Set 350 as input and applies the Trained Feature Contribution Category Classification Predictive Model 340 (710 in FIG. 7) to the New Feature Contribution Score Set 350 accurately predicting and classifying each feature contribution score set item to an appropriate category classification label. The Apply Supervised Feature Contribution Category Classification Model component 361 is discussed in more detail below with respect to FIG. 8.

FIG. 8 shows a diagram 800 of applying the supervised feature contribution category classification model, according to an embodiment.

At 801, based on the feature contribution score category classification process, a new feature contribution score set (350 in FIG. 3) is accepted as input with the same data structure as outlined in the Feature Contribution Score Set Pre-processing part (320 in FIG. 3).

At 803, when a New Feature Contribution Score Set is obtained (801), for each Feature Contribution Score Item, the same engineered features as used in the Feature Contribution Score Category Classification Learning part are derived and, at 804, combined with the Feature Contribution Score of the Feature Contribution Score Item forming the input features for the predictive model.

At 805, the trained Supervised Feature Contribution Category Classification Model (710 in FIG. 7) is applied, accurately predicting, and assigning an appropriate category classification label.

At 806, the predicted Category Classification Label is then combined with the Feature Contribution Score Set Item.

At 807, it is determined whether all feature contribution score set items have been processed and if not, the algorithm returns to 802.

If it is determined at 807 that all feature contribution score set items have been processed, as output a Feature Contribution Score Set 810 is produced where each feature contribution score set item has a category classification label assigned, intuitively informing the strength of its contribution towards a selected target feature. Thus, the Automatic Category Classification Framework for Feature Contribution Scores solution fulfils the Intuitive Feature Contribution Score Set Classification Labelling problem described above.

### Example Computer Hardware

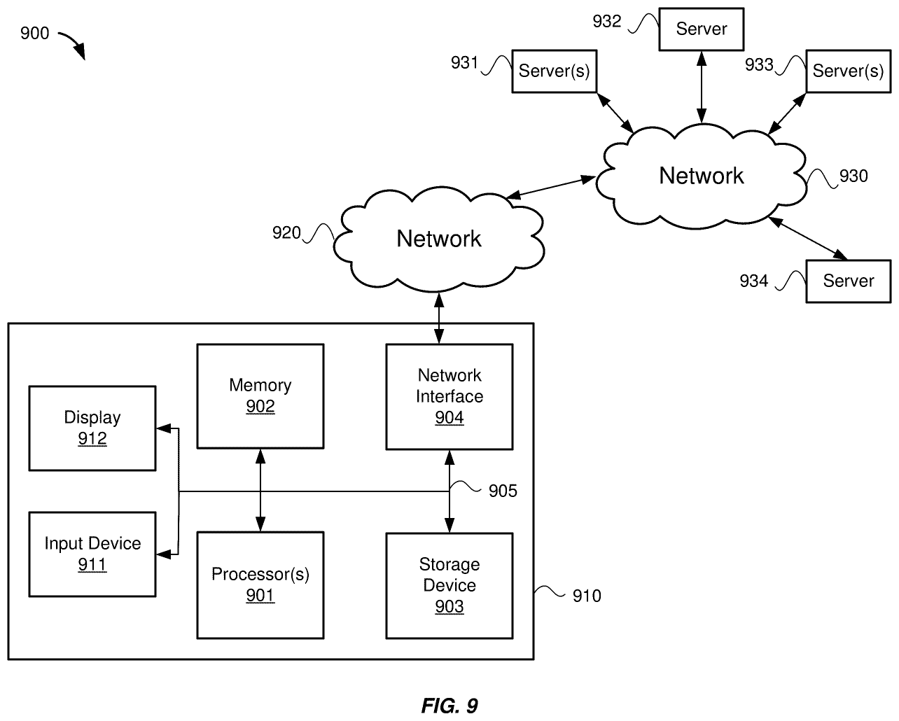

FIG. 9 shows a diagram 900 of hardware of a special purpose computing system 910 for implementing the systems and methods described herein. The computer system 910 includes a bus 905 or other communication mechanism for communicating information, and one or more processors 901 coupled with bus 905 for processing information. The computer system 910 also includes a memory 902 coupled to bus 905 for storing information and instructions to be executed by processor 901, including information and instructions for performing some of the techniques described above, for example. This memory may also be used for storing programs executed by processor(s) 901. Possible implementations of this memory may be, but are not limited to, random access memory (RAM), read only memory (ROM), or both. A storage device 903 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 903 may include source code, binary code, or software files for performing the techniques above, such as the processes described above, for example. Storage device and memory are both examples of non-transitory computer readable storage mediums.

The computer system 910 may be coupled via bus 905 to a display 912 for displaying information to a computer user. An input device 911 such as a keyboard, touchscreen, and/or mouse is coupled to bus 905 for communicating information and command selections from the user to processor 901. The combination of these components allows the user to communicate with the system. In some systems, bus 905 represents multiple specialized buses, for example.

The computer system also includes a network interface 904 coupled with bus 905. The network interface 904 may provide two-way data communication between computer system 910 and a network 920. The network interface 904 may be a wireless or wired connection, for example. The computer system 910 can send and receive information through the network interface 904 across a local area network, an Intranet, a cellular network, or the Internet, for example. In the Internet example, a browser, for example, may access data and features on backend systems that may reside on multiple different hardware servers 931-934 across the network. The servers 931-934 may be part of a cloud computing environment, for example.

### Example Application of the Automatic Category Classification Framework

The Automatic Category Classification Framework for Feature Contribution Scores solution can be applied in any application where labelling of feature contribution scores to interpretable human readable category classification labels is useful. To demonstrate the proposed solution, the inventor applied it to a cloud-based data analytics software where the output feature contribution scores from a machine learning model are required to be mapped to intuitive human readable classification labels. This data analytics software is configured to execute a Machine Learning algorithm to uncover new or unknown relationships between columns within a dataset and provide an overview of the dataset by automatically building charts to enable information discovery from the data.

The data analytics software is configured to output a list of “key influencers,” which are the top ranked features of the dataset that significantly impact a selected target. For each listed Key Influencer there exist specific information panels to illustrate the relationship between the influencer and the target. One of the specific information panels is a table (example below) where the Feature Contribution Scores are classified with category classification labels assigned.

| | Influence | Column | Correlations |
|---|---|---|---|
| ◯◯◯ | STRONG | Recent Form | Athlete Previous Runs |
| ◯ | WEAK | Athlete ID | — |
| ◯ | WEAK | Athlete Age | — |
| ◯ | WEAK | Athlete Previous Runs | Recent Form |

### Key Influencers of Dressage Score for Unique ID

This example table indicating the influence (contribution) of features is where the feature contribution classification techniques described above may be applied.

Without using the feature contribution classification techniques described above, the Labelled Feature Contribution Score panel may classify the underlying feature contribution scores of the feature contribution score items based on the application of absolute thresholds, with three category classification labels existing.

For example, a label of “Weak” may be applied for a threshold of ≥0.0 and <0.22.

A label of “Moderate” may be applied for an absolute threshold of ≥0.22 and <0.5.

And a label of “Strong” may be applied for an absolute threshold of ≥0.5

One challenge with the absolute threshold approach is it fails to consider the distribution of the Feature Contribution Score Set, or the position of each Feature Contribution Score Set Items' score within the distribution, often resulting in poor category classification labelling of feature contribution scores.

The Automatic Category Classification Framework for Feature Contribution Scores solution described above addresses this concern through utilizing a supervised learning algorithm to accurately predict the category classification label based on the score of a feature contribution score set item and engineered features describing the distribution of the related Feature Contribution Score Set and the position of the feature contribution score set items' score within the distribution.

In the application of the Automatic Category Classification Framework for Feature Contribution Scores solution, its performance was compared against the application of absolute thresholds, using the three category classification labels based on thresholds as described above. In one example, the results of the comparison indicate an average accuracy of 98% for the Feature Contribution Category Classification Predictive Model displaying a significant improvement over the Absolute Fixed Threshold direction (average accuracy 74%). Furthermore, the Feature Contribution Category Classification Predictive Model maintains a consistent accuracy across all feature set sizes with a standard deviation of 2.22%, while the Absolute Fixed Threshold direction presenting a standard deviation of 15.21%.

The a comparison of the results for the labels “low,” “moderate,” and “strong” are described below.

For the “low” labels, the results indicate an average accuracy of 99% achieved for the Feature Contribution Category Classification Predictive Model and average accuracy of 99% for the applied Absolute Thresholds, with marginal difference in standard deviation. This indicates equivalent high accuracy and performance achieved with each approach for the Category Classification Label, “Low.”

For the “moderate” label, the results indicate an average accuracy of 93% for the Feature Contribution Category Classification Predictive Model and average accuracy of 9.92% for the applied Absolute Thresholds. This indicates high accuracy was achieved for the Feature Contribution Category Classification Predictive Model approach, and poor accuracy achieved for the Absolute Threshold Approach. The comparison demonstrates superior accuracy and performance is consistently achieved by the Feature Contribution Category Classification Predictive Model across all Feature Contribution Score Set sizes for the Category Classification Label, “Moderate.”

For the “strong” label, The results indicate an average accuracy of 88.35% for the Feature Contribution Category Classification Predictive Model and average accuracy of 10.01% for the applied Absolute Thresholds. This indicates high accuracy was achieved for the Feature Contribution Category Classification Predictive Model approach, with poor accuracy achieved for the Absolute Threshold Approach. Furthermore, the comparison demonstrates superior accuracy and performance is achieved by the Feature Contribution Category Classification Predictive Model across 24 of the 25 Feature Contribution Score Set sizes for the classification of the Category Classification Label, “Strong.”

Through following the Automatic Category Classification Framework for Feature Contribution Scores, Feature Contribution Score Sets can have Category Classification Labels assigned with high accuracy, while continuing to provide intuitive interpretation to non-expert users. From an organization perspective, the ability to reliably label feature contribution scores produced from some machine learning model as intuitive human readable labels with high accuracy is seen as greatly helpful in business decision making.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A computer system, comprising:
one or more processors; and
one or more machine-readable medium coupled to the one or more processors and storing computer program code comprising sets of instructions for executable by the one or more processors to:
obtain a historical feature contribution score dataset comprising a number of sets of scores generated by machine learning model;
materialize additional feature contribution score sets such that the size of each additional feature contribution score set is based on a corresponding randomly selected values within a set-size range;
produce a training dataset including feature contribution scores and corresponding classification labels extracted from the historical feature contribution score dataset and the additional feature contribution score sets, the classification labels indicating an amount that the corresponding feature contribution scores contribute to a prediction of a target feature;
train a machine learning model to predict the classification labels using the training dataset; and
apply an input feature contribution score set to the machine learning model to obtain predicted classification labels.

2. The computer system of claim 1, wherein materializing additional feature contribution score sets includes randomly generating scores based on a number of sample score-ranges.

3. The computer system of claim 1, wherein the materializing of the additional feature contribution score sets includes normalizing score values of the additional feature contribution score.

4. The computer system of claim 1, wherein classification labels are assigned to the scores of additional feature contribution score sets after they are materialized.

5. The computer system of claim 1, wherein the computer program code further comprises sets of instructions executable by the one or more processors to:
determine a deficit number based on the number of the sets of scores in the feature contribution score dataset and a predefined number of feature contribution score sets, the materializing of the additional feature contribution score sets based on the deficit number.

6. The computer system of claim 1, wherein the computer program code further comprises sets of instructions executable by the one or more processors to:
derive engineered features based on the historical feature contribution score dataset, the additional feature contribution score sets, and one or more of a maximum feature contribution score, a minimum feature contribution score, a mean feature contribution score, a distance to the maximum feature contribution score, a distance to the minimum feature contribution score, a distance to the mean feature contribution score, and a variance of feature contribution scores.

7. The computer system of claim 6, wherein the computer program code further comprises sets of instructions executable by the one or more processors to:
derive engineered features based on the input feature contribution score set, wherein the input feature contribution score set applied to the machine learning model is based on the engineered features derived based on the input feature contribution score set.

8. One or more non-transitory computer-readable medium storing computer program code comprising sets of instructions to:
obtain a historical feature contribution score dataset comprising a number of sets of scores generated by machine learning model;
materialize additional feature contribution score sets such that the size of each additional feature contribution score set is based on a corresponding randomly selected values within a set-size range;
produce a training dataset including feature contribution scores and corresponding classification labels extracted from the historical feature contribution score dataset and the additional feature contribution score sets, the classification labels indicating an amount that the corresponding feature contribution scores contribute to a prediction of a target feature;
train a machine learning model to predict the classification labels using the training dataset; and
apply an input feature contribution score set to the machine learning model to obtain predicted classification labels.

9. The non-transitory computer-readable medium of claim 8, wherein materializing additional feature contribution score sets includes randomly generating scores based on a number of sample score-ranges.

10. The non-transitory computer-readable medium of claim 8, wherein the materializing of the additional feature contribution score sets includes normalizing score values of the additional feature contribution score.

11. The non-transitory computer-readable medium of claim 8, wherein classification labels are assigned to the scores of additional feature contribution score sets after they are materialized.

12. The non-transitory computer-readable medium of claim 8, wherein the computer program code further comprises sets of instructions to:
determine a deficit number based on the number of the sets of scores in the feature contribution score dataset and a predefined number of feature contribution score sets, the materializing of the additional feature contribution score sets based on the deficit number.

13. The non-transitory computer-readable medium of claim 8, wherein the computer program code further comprises sets of instructions to:
derive engineered features based on the historical feature contribution score dataset, the additional feature contribution score sets, and one or more of a maximum feature contribution score, a minimum feature contribution score, a mean feature contribution score, a distance to the maximum feature contribution score, a distance to the minimum feature contribution score, a distance to the mean feature contribution score, and a variance of feature contribution scores.

14. The non-transitory computer-readable medium of claim 13, wherein the computer program code further comprises sets of instructions to:
derive engineered features based on the input feature contribution score set, wherein the input feature contribution score set applied to the machine learning model is based on the engineered features derived based on the input feature contribution score set.

15. A computer-implemented method, comprising:
obtaining a historical feature contribution score dataset comprising a number of sets of scores generated by machine learning model;
materializing additional feature contribution score sets such that the size of each additional feature contribution score set is based on a corresponding randomly selected values within a set-size range;
producing a training dataset including feature contribution scores and corresponding classification labels extracted from the historical feature contribution score dataset and the additional feature contribution score sets, the classification labels indicating an amount that the corresponding feature contribution scores contribute to a prediction of a target feature;
training a machine learning model to predict the classification labels using the training dataset; and
applying an input feature contribution score set to the machine learning model to obtain predicted classification labels.

16. The computer-implemented method of claim 15, wherein materializing additional feature contribution score sets includes randomly generating scores based on a number of sample score-ranges.

17. The computer-implemented method of claim 15, wherein the materializing of the additional feature contribution score sets includes normalizing score values of the additional feature contribution score.

18. The computer-implemented method of claim 15, wherein classification labels are assigned to the scores of additional feature contribution score sets after they are materialized.

19. The computer-implemented method of claim 15, further comprising:
determining a deficit number based on the number of the sets of scores in the feature contribution score dataset and a predefined number of feature contribution score sets, the materializing of the additional feature contribution score sets based on the deficit number.

20. The computer-implemented method of claim 15, further comprising:
deriving engineered features based on the historical feature contribution score dataset, the additional feature contribution score sets, and one or more of a maximum feature contribution score, a minimum feature contribution score, a mean feature contribution score, a distance to the maximum feature contribution score, a distance to the minimum feature contribution score, a distance to the mean feature contribution score, and a variance of feature contribution scores.
